(19) United States
(12) Patent Application Publication
(10) Pub. No.: US 2014/0074656 A1
(43) Pub. Date: Mar. 13, 2014

(54) BARTERING USING INDUCTIVE AND DEDUCTIVE PROCESSES

(71) Applicant: Tamio Stehrenberger, Draper, UT (US)

(72) Inventor: Tamio Stehrenberger, Draper, UT (US)

(21) Appl. No.: 14/022,051

(22) Filed: Sep. 9, 2013

Related U.S. Application Data
(60) Provisional application No. 61/698,214, filed on Sep. 7, 2012.

(51) Int. Cl. G06Q 30/06

(52) U.S. Cl. CPC G06Q 30/0619
USPC 705/26.44

(57) ABSTRACT

A method of facilitating bartering includes receiving a first input from a first user, a second input from a second user, and entering the inputs into a database to create a listing for each user. The first input includes a first item for trade and a criteria for trade. The second input includes a second item and a category of items or subcategory of items to be obtained that satisfies the criteria for trade. The method further includes searching and filtering items within the database to identify a match, generating an electronic message including information related to the match and sending the electronic message to at least one of the first user and the second user, and enabling the first and second users to respond to the electronic message and share contact information.

### CROSS REFERENCE TO RELATED APPLICATIONS

This application claims the benefit of U.S. Provisional Application No. 61/698,214, filed on Sep. 7, 2012, entitled, “Bartering Using Inductive and Deductive Processes,” which is incorporated by reference herein in its entirety.

### BACKGROUND

Since humans first began trading, there is an inherent problem economists call the double coincidence of needs, meaning the odds are slim that Person A has what Person B wants, and in return Person B has what Person A wants. Humans invented money to help solve that problem.

Today with the down economy and cash being scarce, people turn to alternative ways to get things they want and need without using money. Barter and Trade is a growing market in need of increased efficiency and productivity.

### SUMMARY

Embodiments of a method of facilitating bartering are described. In one embodiment, the method of facilitating bartering includes receiving a first input from a first user of a plurality of users, receiving a second input from a second user of the plurality of users, and entering the first and second inputs into a database to create a listing for each of the first item and the second item. The first input includes at least one first item for trade and at least one criteria for a trade of the first item. The second input includes at least one second item for trade and a category of items or subcategory of items to be obtained. At least one of the category of items or subcategory of items includes criteria for a trade of the second item. The method further includes searching and filtering items or listings within the database to identify a match. The match includes an available first item of a first user and an available second item of a second user. The available first item of the first user satisfies at least one criteria for the trade of the second item. The available second item of the second user satisfies at least one criteria for the trade of the first item. The method further includes generating an electronic message including information related to the match and sending the electronic message to at least one of the first user and the second user and enabling the first and second users to respond to the electronic message and share contact information. Other embodiments of a method of facilitating bartering are also described. Embodiments of a system for facilitating bartering are also described, as well as embodiments of a computer program product.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts one embodiment of a schematic diagram of two persons bartering.

FIG. 2 depicts one embodiment of a schematic diagram of a system for electronic bartering.

FIG. 3 depicts one embodiment of a method for facilitating bartering.

FIG. 4 depicts a schematic diagram of one embodiment of listings of items for trade and matching using inductive matching.

FIG. 5A depicts a schematic diagram of one embodiment of listings of items for trade and matching using inductive matching.

FIG. 5B depicts the schematic diagram of FIG. 5A of one embodiment of listings of items for trade after matching using inductive matching.

FIG. 6 depicts a schematic diagram of an embodiment using filters to filter out listings that satisfy category and subcategory criteria.

FIG. 7A depicts a schematic diagram of one embodiment of a system for utilizing both inductive and deductive matching.

FIG. 7B depicts a schematic diagram of one embodiment of a system for utilizing both inductive and deductive matching where filtering eliminates possible listings.

FIG. 8 depicts an embodiment of a trading process performed in accordance with embodiments of the technologies, methods, and systems described herein.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

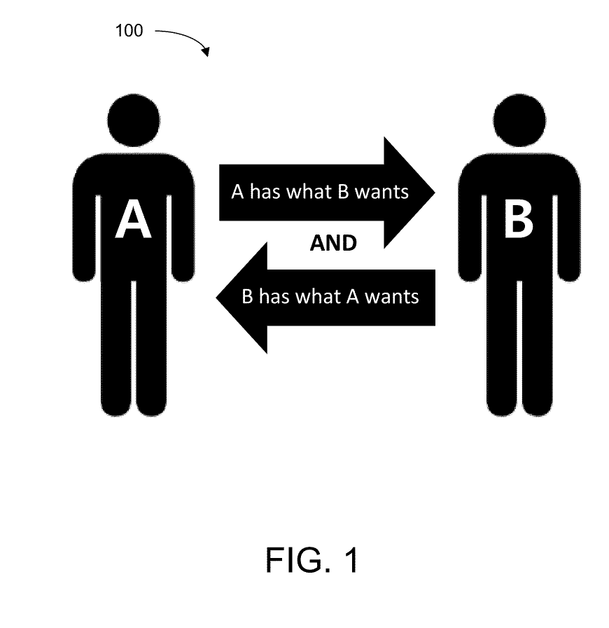

FIG. 1 depicts one embodiment of a schematic diagram of two persons bartering 100. Since humans first began trading, there is an inherent problem economists call the double coincidence of needs, meaning the odds are slim that Person A has what Person B wants, and in return Person B has what Person A wants. Humans invented money to help solve that problem.

Today with the down economy and cash being scarce, people turn to alternative ways to get things they want and need without using money. Barter and Trade is a growing market.

Currently, the most popular way to barter/trade online is to use popular online classified ads. Here people can post an advertisement for what they have, and others can spend considerable time searching through ads for what they want. Although online classifieds were made mainly for buying and selling, many offer a BARTER section where users can post what they have, and type in the ad things they want to trade for.

The problem is that it is very time consuming not only to search for things you want, but also to hope you have something they want in return. Because the process of searching, emailing, and waiting to hear back is very tedious, it is more a rarity that trades actually happen.

There is no way to determine if a person who posted an advertisement is honest or legitimate. For businesses looking to trade, business barter networks are often cost-prohibitive due to high set up fees and commissions. Furthermore, current bartering networks may issue trade credits that are often wasted as they are difficult to use.

While many embodiments are described herein, at least some of the described embodiments facilitate the exchange of items (e.g., goods and/or services) between individuals using a unique process in which each of the items are arranged into a hierarchical system of categories. Some embodiments allow user identity and/or personal information to be kept confidential until a suitable match is found. Some embodiments increase efficiency of trades and increase user satisfaction as users can decide preliminarily whether to proceed and disclose contact information.

The technologies described herein generally relate to electronic systems and methods for bartering or trading goods or services. In some embodiments, a first user may input one or more items, such as goods and/or services, that they want to trade as well as one or more items that they want to acquire. A listing may be created that includes the first users input. For example, the items may be grouped within the listing by category. Such categories may include, but are not limited to, type of item, price range, location, etc. The listing created for the first user may be compared with listings created for other users to generate one or more matches. The matches may be reported to one or more of the users. If the user chooses to accept the trade, they may be provided with a means of contacting the other user. Thus, the users' identity and contact information is protected.

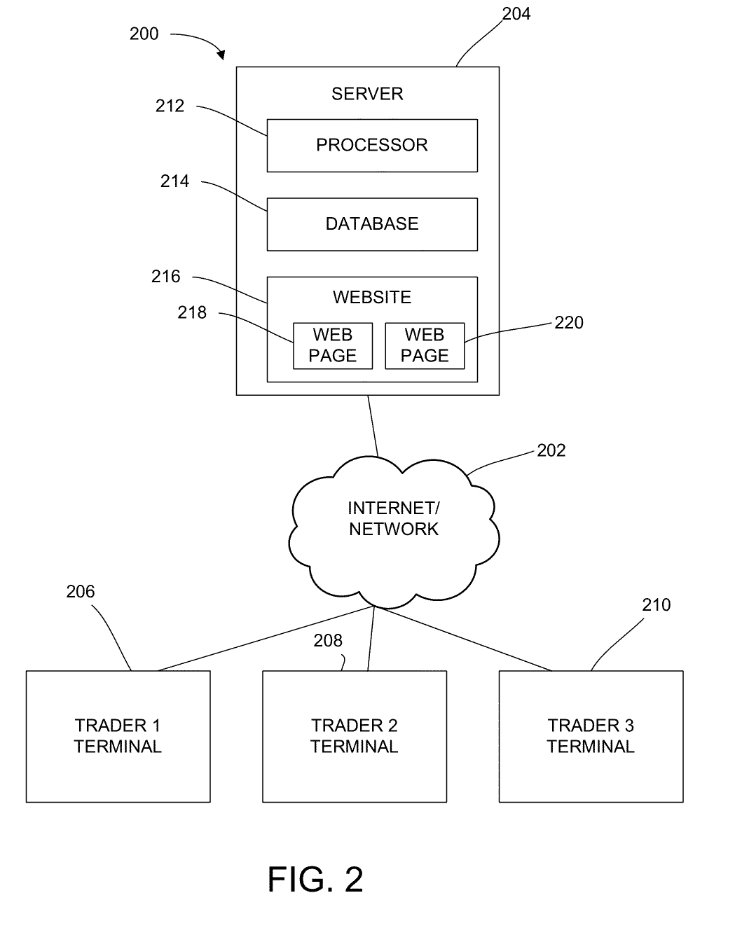

FIG. 2 depicts one embodiment of a schematic diagram of a system for electronic bartering 200. The system for electronic bartering 200 may be configured to be used on a network/internet 202 with conventional servers 204 and terminals 206-210. The server 204 may include a processor 212, a database 214, and may be used to host a website 216 including one or more web pages 218-220. The server 204 may communicate with one or more user interfaces 206-210, such as Trader 1 Terminal 206, Trader 2 Terminal 208, and Trader 3 Terminal 210 via the network/internet 202.

Some embodiments enable users to create a listing on the website 216 with items/services they are offering, input the items/services they are interested in trading for, and the system inductively and deductively creates trade matches, as will be described in further detail. In some embodiments, the listing may include, for example, the items that the user wants to trade and the items the user wants to acquire. The system 200 may be configured to receive information used to generate the listings from the users, who may input the information into the system 200 using Trader 1 Terminal 206, Trader 2 Terminal 208, and Trader 3 Terminal 210. For example, the trader terminals 206-210 may be used to access the web site 216 which acts as an interface that enables the users to input the information into the system 200. In some embodiments, users input information into the website 216. In some embodiments, users input information into an app on a mobile device or computer. The input may be made on many different types of computing devices including but not limited to a mobile phone, computer, laptop, tablet, or other computing device. The input may be made through many different platforms including but not limited to a website, an application or program downloaded to a computing device, an email or other electronic communication platform.

The information may include details about the products and/or services the user wishes to trade or acquire, such as, a name or other identifier for the items, a description of the items and/or pictures of the items. For example, for the items the user wants to trade, the user may specify the item by name or identifier, may provide a description of the item and may upload a picture showing the item. The user may also provide a price range for the item. For the items the user wants to acquire, the user may specify a particular item, may specify a category or subcategory of items, may select all items falling within the price range of the item they want to trade, or may be open to all offers.

The information input by the user may be categorized to generate the listing for each user that includes the item(s) the user wants to trade and the item(s) the user wants to acquire, and the listing may be stored on the database 214. The system 200 may then compare the listings to generate a match between users with items that may be traded for one another. An electronic message may be generated and sent to one or more of the users that enables the users to accept or decline the match. For example, the system may send the electronic message to the users via the trade terminals 206-210. If the user accepts the match, they may be provided with a means of communicating with the other user. As a non-limiting example, the user may be provided with contact information for the other user, or the users may communicate over an online message board. The contact information for a user may be withheld from other users until certain milestones within the process. The milestone may be but is not limited to after a match is found, after receipt of an electronic message, after a response to the electronic message from the user, after the two users come to an agreement to exchange items, after a checkout and payment to a third party processor of the transaction or any other milestone in the process.

Technologies described herein also relate to methods of bartering between individuals. The methods may facilitate the exchange of items (e.g., goods and/or services) between individuals using a unique process in which each of the items are arranged into a hierarchical system of categories. For example, the item may be a tablet computer, such as an IPAD tablet, and it may be categorized in the following way:

Products→Electronics→Computers→Tablets

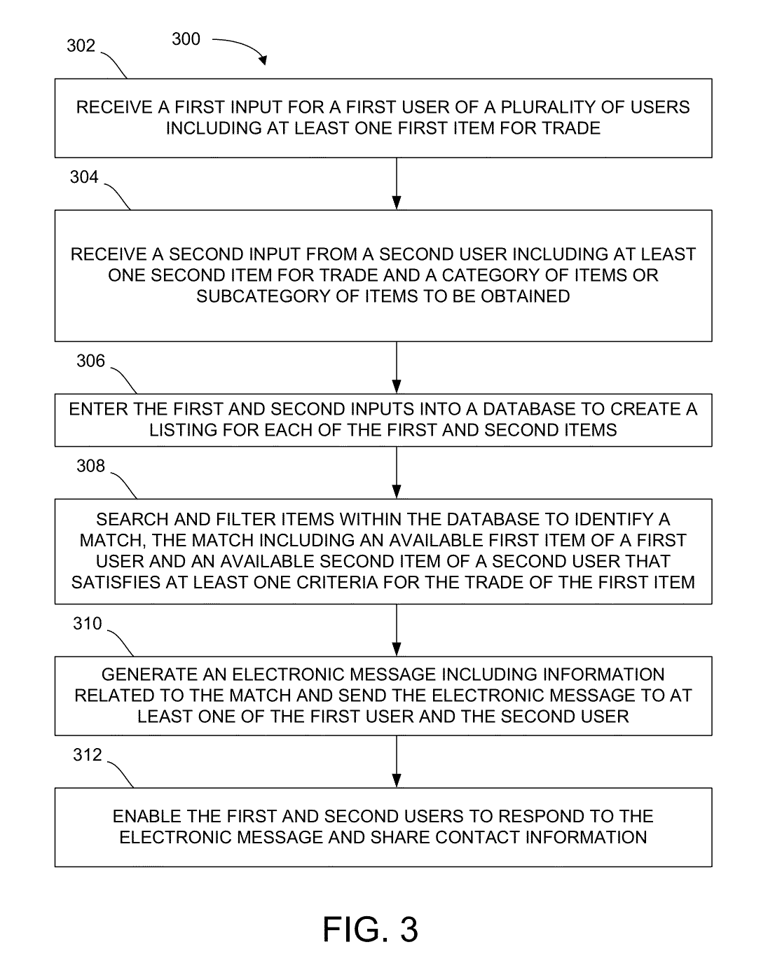

FIG. 3 depicts one embodiment of a method for facilitating bartering 300. The method of bartering 300 may be performed using the system 200 described above. Although the method 300 is described in conjunction with the system for electronic bartering 200 of FIG. 2, embodiments of the method for facilitating bartering 300 may be implemented with other types of systems.

At 302, a first input from a first user of a plurality of users is received. In some embodiments, the first input includes at least one item for trade and at least one criteria for a trade of the item. The input may be made a trader terminal 206 and received at a server 204. In some embodiments, the at least one criteria for the trade of the item includes a price range for the item.

At 304, a second input from a second user of the plurality of users is received. In some embodiments, the second input includes another item for trade. In some embodiments, the second input includes a category of items or subcategory of items to be obtained. In some embodiments, at least one of the category of items or subcategory of items satisfies at least one criteria for the trade of the first item. In some embodiments, the at least one of the category of items or subcategory of items comprises a criteria for a trade of the second item. In some embodiments, the at least one of the category of items or subcategory of items comprises all available trades for goods and/or services having a value within the price range for the first item.

At 306, the first input and the second input are entered into a database to create a listing for each of the first item and the second item. In some embodiments, the listing may include the item for trade, criteria for the trade of the item, a price range for the item, a category for the item, subcategories for the item, other distinguishing information about the item, and all this information or a specific combination thereof.

At 308, items or listings within the database are searched and filtered to identify a match. In some embodiments, the match includes an available first item of a first user and an available second item of a second user. In some embodiments, the information of the available first item will satisfy a criteria for a trade of the second item and the information of the available second item will satisfy a criteria for a trade of the first item. In some embodiments, the searching and filtering includes searching and filtering a plurality of categories and subcategories to eliminate non-matching items and/or listings. In some embodiments, each of the plurality of categories and subcategories is based on at least one of a type, a classification, a price range, and a location of the at least one item, or a location of the first or second user. In some embodiments, the searching and filtering includes using inductive matching. An inductive matching process may be performed via keywords, categorizing of products/services, and algorithms to find the specific trade. In some embodiments, the searching and filtering includes using deductive matching. Filters may be used for deductive matching. Filters may include but are not limited to price range, location, categories and sub-categories, etc. In some embodiments, the available second item falls within the price range for the first item of the first user.

At 310, an electronic message including information related to the match is generated and set to the first user. In some embodiments, the electronic message is sent to the second user. In some embodiments, the electronic message is sent to both the first and the second user.

At 312, the first and second users are able to respond to the electronic message and share contact information. The depicted method 300 then ends.

Embodiments described herein, thus, generate matches of what Person A has, and what he wants, to Person B with their respective haves and wants. With the failing of the monetary system, bartering and trading is on the rise. The embodiments disclosed herein provide systems and methods for providing match trades/barters to users while saving time and energy and enabling more trading to happen.

Another big issue today is protecting our personal information. Posting private information on the Internet can be annoying and even dangerous. Getting mass SPAM emails, soliciting phone calls, and text messages is minimal to the dangers of giving out home addresses. In some embodiments, users' personal information is only released upon finding a match. Because the users' personal information is only released when and to other users they want, such personal information is protected. In some embodiments, the users' information such as name, address and phone number may be verified to protect other users, and user feedback may be provided to show how users have performed in the past.

Matching up trades of what people have and want is very complex because of the vast variations people may have and want, from people wanting only specific trade, others being open to any trade offers with no preconceived ideas of what they want, products and services, differing price ranges, to everything and anything in between.

The systems and methods describe herein takes into account different possibilities and situations of matching using Inductive matching, Deductive matching, or combination thereof.

1. Inductive Matching

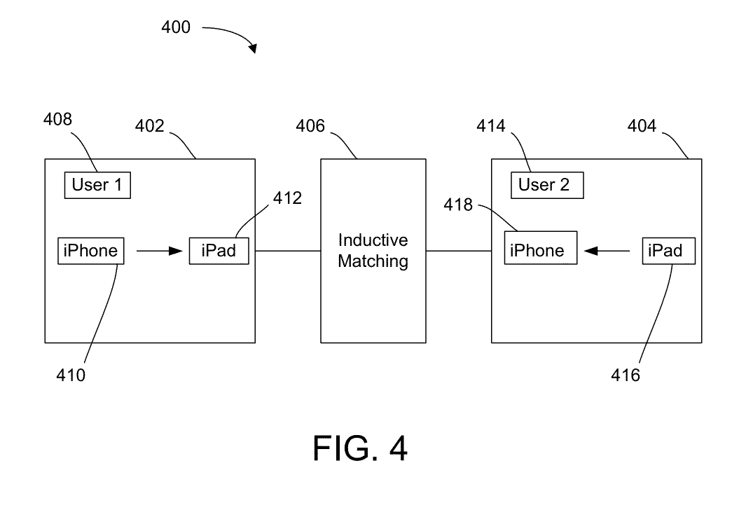

FIG. 4 depicts a schematic diagram 400 of one embodiment of listings of items for trade 402-404 and matching using inductive matching 406. Each listing 402-404 provides information for a trade. In the depicted listing 402, a first user 408 lists an item for trade 410 (an iPhone) and a criteria 412 (an iPad) for a trade of the item 410. In the depicted listing 404, a second user 414 lists an item for trade 416 (an iPad) and a criteria 418 (iPhone) for a trade of the item 416. In some embodiments, more information may be listed including but not limited to condition of the item, age of the item, distinguishing characteristics of the item, or additional criteria for trade of the item.

One-to-one trading. Some traders are specific in what they want to trade for. As shown in FIG. 4, User 1 wants to trade his IPHONE for an IPAD. User 2 wants to trade his IPAD for an IPHONE. There is only one outcome these users both want. An inductive matching process 406 may be performed via keywords, categorizing of products/services, and algorithms to find the specific trade.

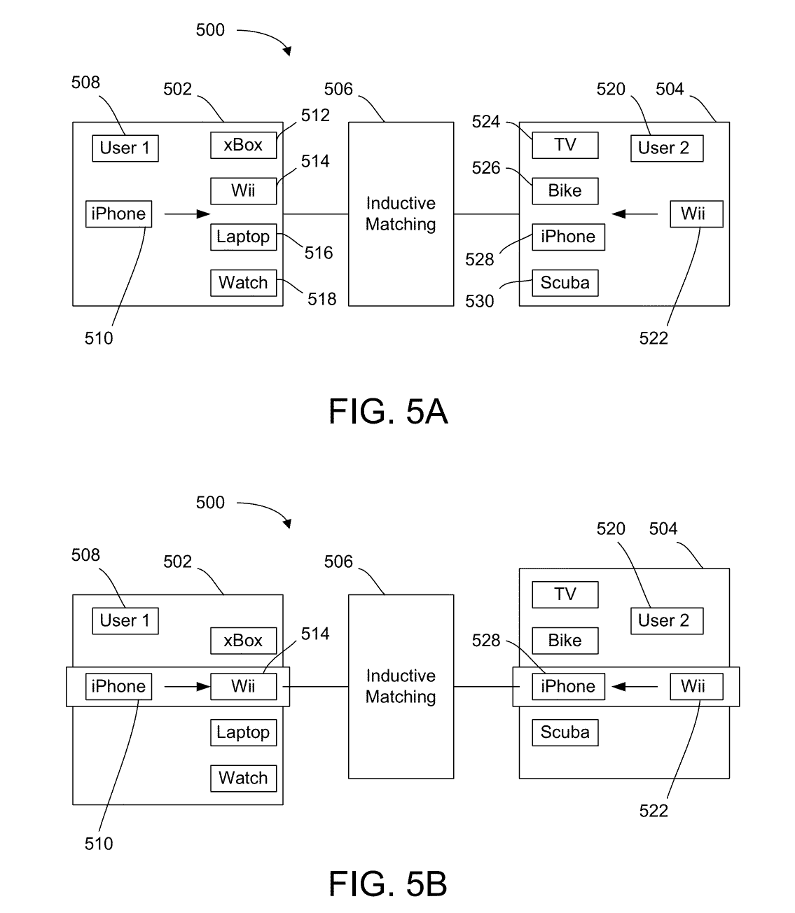

Multiple wants trading—finding the common denominator. FIG. 5A depicts a schematic diagram 500 of one embodiment of listings of items for trade 502-504 and matching using inductive matching 506. Each listing 502-504 provides information for a trade. In the depicted listing 502, a first user 508 lists an item for trade 510 (an iPhone) and multiple criteria 512-518 (an xBox, a Wii, a laptop, or a watch) for a trade of the item 510. In the depicted listing any one of the criteria 512-518 will satisfy a trade. In the depicted listing 504, a second user 520 lists an item for trade 522 (a Wii) and multiple criteria 524-530 for a trade of the item 522. In some embodiments, more information may be listed including but not limited to condition of the item, age of the item, distinguishing characteristics of the item, or additional criteria for trade of the item.

Some users are willing to trade for several different items. As shown in the Figure below, User 1 has an IPHONE and wants to trade for an XBOX, WIT, Laptop computer, or a watch. User 2 has a WIT, and wants a TV, bike, IPHONE, or something for SCUBA diving. Using the inductive matching 506 by keywords, categorizing, and algorithms, common trade denominators may be identified to line up the trade.

FIG. 5B depicts the schematic diagram 500 of FIG. 5A of one embodiment of listings of items for trade 502-504 after matching using inductive matching 506. In listing 502, the item for trade 510 (an iPhone) may be traded for any of multiple criteria 512-518 (an xBox, a Wii, a laptop, or a watch). In listing 504, the item for trade 522 (a Wii) may be traded for any of multiple criteria 524-530 (iPhone). After searching and filtering through many listings, a match may be found between listing 502 and listing 504. The item 510 of listing 502 satisfies the criteria 528 of listing 504 and the item 522 satisfies the criteria 514 of listing 502. In some embodiments, listings are not shown to other users until a match if found. In some embodiments, the listing is only shown to the users of the match.

2. Deductive Matching Using Filters

Often times, users are not as specific as the examples above using inductive matching. Instead of inputting specific information, such as brand, trade name, model number, etc., (e.g., APPLE, IPAD3, model number #A10343), users may input a general description (e.g., “tablet”). A deductive way of matching using many different filters would enable matching of the item. This inputted “Tablet” is then grouped into a breadcrumb trail of categories and sub-categories. Filters may include but are not limited to price range, location, categories and sub-categories, etc.

For example, if a user inputs a tablet computer that they would like to trade, filtering may be performed by the price of what the tablet computer may be worth, all listings may be filtered out that do not fall under the following subcategory trail:

Products→Electronics→Computers→Tablets

Any and every other category and sub-category that do not fall into the above subcategory trail may then be deleted and filtered out. Below are several examples of grouped listings in categories that would be deleted/omitted as a “trade match:”

Products→Electronics→Computers→Laptops

Products→Books→Non-fiction

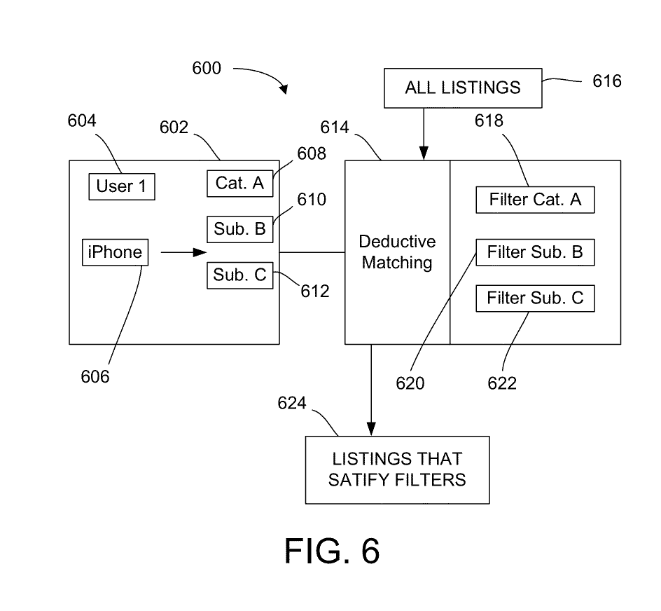

FIG. 6 depicts a schematic diagram 600 of an embodiment using filters 618-622 to filter out listings 624 that satisfy category and subcategory criteria. In the depicted embodiment, a listing 602 of a first user 604 lists an item for trade 606 (an iPhone) and category and subcategories 608-612 that will satisfy a trade for the item 606. Deductive matching 614 occurs as all listings 616 are filtered through filters 618-622. Only listings 624 that satisfy filters 618-622 are listed. The listings 624 must also have a criteria that is satisfied by listing 602. In some embodiments, all filters must be satisfied. In some embodiments, satisfaction of any single filter will suffice.

As shown above, one or more of the categories and subcategories are used as filters to eliminate or delete items that the user would not be interested in so that they will not be presented to the user as potential trade matches. This deductive way of matching also works in the case where users are open to all offers with the main or sole filter being price. All listings not in the appropriate price range are filtered out creating an open list of all possible trades in that user's item's price range to which the user can accept or decline.

3. Combination of Inductive and Deductive Matching

The systems and methods described herein may utilize both inductive and deductive matching as seen in the example below.

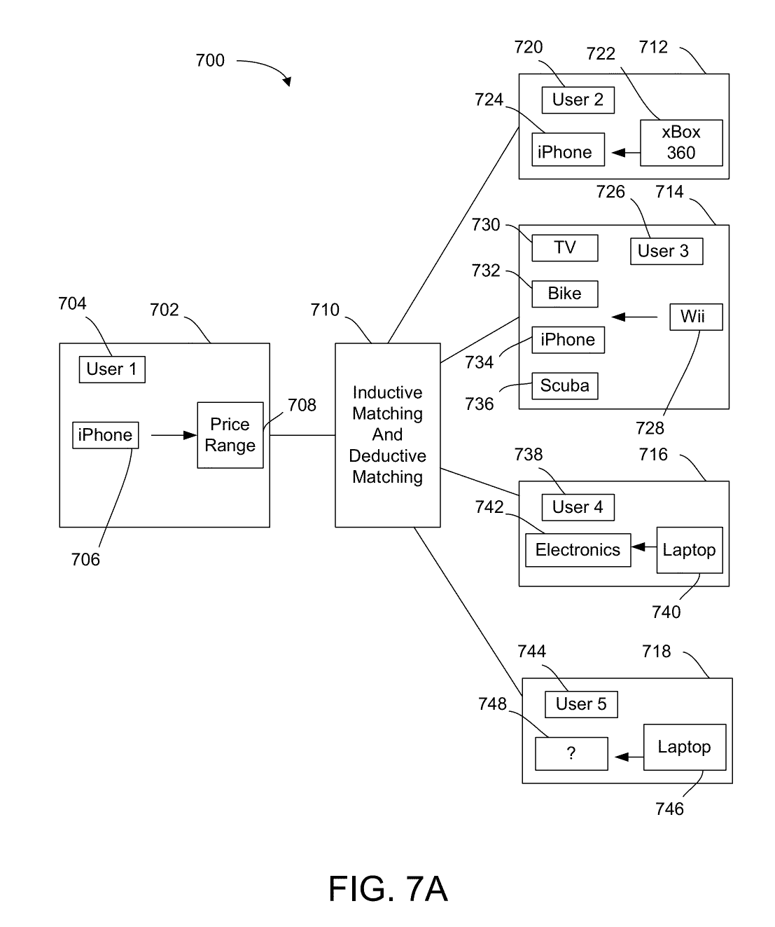

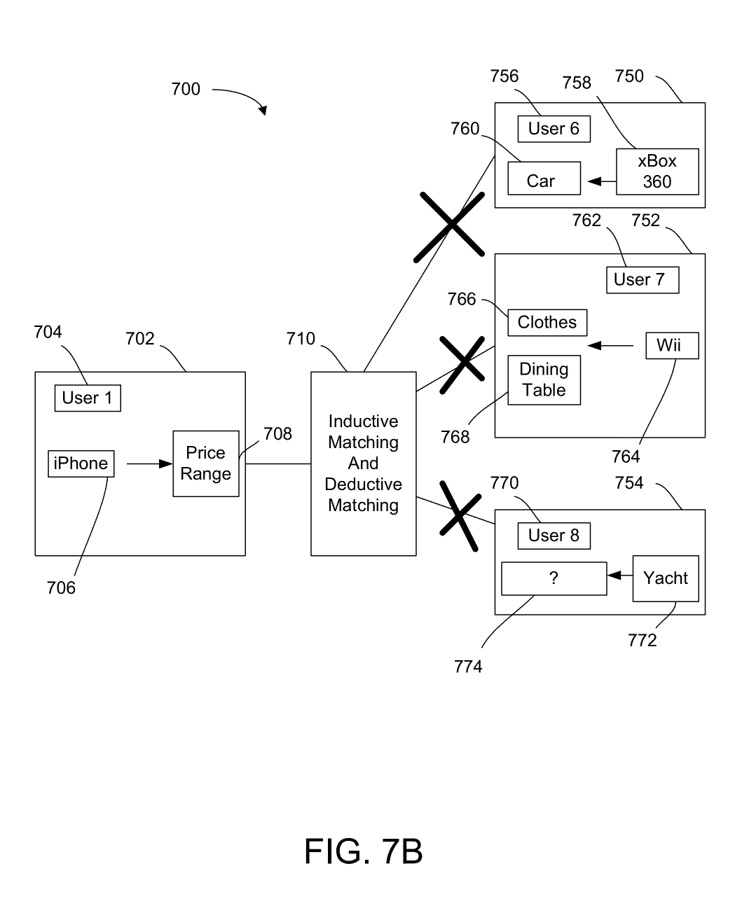

FIG. 7A depicts a schematic diagram 700 of one embodiment of a system for utilizing both inductive and deductive matching. In the depicted embodiment, a listing 702 of a first user 704 lists an item for trade 706 (an iPhone) and a price range 708 that will satisfy a trade for the item 706 but no other criteria or filters. Inductive and deductive matching 710 occurs as all listings 712-718 that satisfy criteria are listed. In listing 712, a second user 720 lists an item for trade 722 (an xBox) and a criteria 724 (an iPhone) that will satisfy a trade for the item 722 but no other criteria or filters. In listing 714, a third user 726 lists an item for trade 728 (a Wii) and multiple criteria 730-736 for a trade of the item 728. In listing 716, a fourth user 738 lists an item for trade 740 (laptop) and a criteria or filter 742 (electronics) that will satisfy a trade for the item 740. In listing 718, a fifth user 744 lists an item for trade 746 (laptop) and no criteria or filters 748. The listing 702 satisfies each of listings 712-718 and each of listings 712-718 satisfy listing 702.

User 1 has an IPHONE, and is open to all trades. Immediately the system filters out all listings that do not fall within the price range of the IPHONE. Although the price range is used as an example of a filter, the filter may include any criteria determined by the user or the system. The systems and methods described herein facilitate online bartering by filtering out items that the user does not want and matching the user with items they do want. Accordingly, systems and methods described herein eliminate the user's need to search through advertisements for items and provide a simple, efficient and cost effective online bartering by.

The system will search the database and use inductive way to find a trade match with User 2, who has an XBOX360 and wants the IPHONE.

The systems and methods described herein may also use the inductive way of matching to find another user (User 3) who has the WII, but has several wants to trade for. Our invention will find the common trade factor, the IPHONE, and present User 1 with the trade match of the WII.

The systems and methods described herein employ the deductive way of matching by filtering out all other trades that wouldn't be a possibility as illustrated in FIG. 7B.

FIG. 7B depicts a schematic diagram 700 of one embodiment of a system for utilizing both inductive and deductive matching where filtering eliminates possible listings 750-754. Inductive and deductive matching 710 occurs and all listings 750-754 that don't satisfy criteria are eliminated. In listing 750, a sixth user 756 lists an item for trade 758 (an xBox) and a criteria 760 (car) that will satisfy a trade for the item 758. As item 706 does not satisfy criteria 760, listing 750 is eliminated. In listing 752, a seventh user 762 lists an item for trade 764 (a Wii) and multiple criteria 766-768 for a trade of the item 764. As item 706 does not satisfy either criteria 766-768, listing 752 is eliminated. In listing 754, an eighth user 770 lists an item for trade 772 (yacht) and no criteria or filter 774. As the item 772 does not satisfy the price range 708, listing 754 is eliminated.

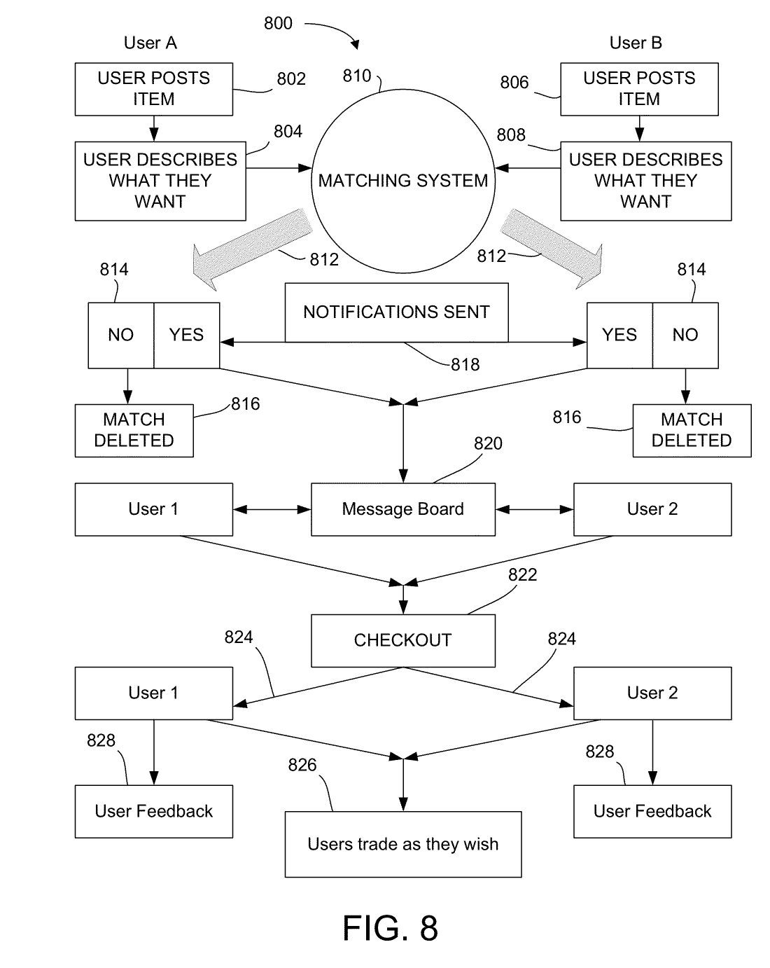

FIG. 8 depicts an embodiment of a trading process 800 performed in accordance with embodiments of the technologies, methods, and systems described herein.

User 1 posts an item/service 802 and inputs what they are interested in trading for 804. User 2 posts an item/service 806 and inputs what they are interested in trading for 808. The systems and methods described herein use inductive and deductive matching to generate trade matches 810.

As matches are generated, they are displayed 812 to both Users 1 and 2 to accept or decline.

If either User declines the trade match 814, the match is deleted 816 from both parties. If both users accept the trade, notifications are sent 818 and a message board is then opened 820 for users to communicate, ask questions, define contracts, etc.

Once both users are ready to trade, they “CHECKOUT” 822 which may or may not entail making a payment of some kind or other necessary information to checkout.

Contact information to both parties 824 may be released so the users can complete the trade 826 independently of the system as they see best fit (meeting in person, mailing, using an escrow agent, etc.). Contact information and other personal information may be withheld from each party until certain points in the process. The point or milestone may be but is not limited to after a match is found, after receipt of an electronic message, after a response to the electronic message from the user, after the two users come to an agreement to exchange items, after a checkout and payment to a third party processor of the transaction or any other milestone in the process.

Once the Users complete the trade, they can return to the system and leave user feedback 828 on how the trade went and the character of the other user for future users to see and understand.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

An embodiment of a system for facilitating bartering includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A method of facilitating bartering, the method comprising:
receiving a first input from a first user of a plurality of users, the first input comprising at least one first item for trade and at least one criteria for a trade of the first item;
receiving a second input from a second user of the plurality of users, the second input comprising at least one second item for trade, and a category of items or subcategory of items to be obtained, wherein at least one of the category of items or subcategory of items comprises a criteria for a trade of the second item;
entering the first and second inputs into a database to create a listing for each of the first item and second item;
searching and filtering items within the database to identify a match, the match comprising an available first item of the first user and an available second item of the second user, wherein the first item of the first user satisfies at least one criteria for the trade of the second item, wherein the second item of the second user satisfies at least one criteria for the trade of the first item;
generating an electronic message comprising information related to the match and sending the electronic message to at least one of the first user and the second user; and
enabling the first and second users to respond to the electronic message and enabling the first and second users to share contact information.

2. The method of facilitating bartering of claim 1, the method further comprising withholding release of contact information and personal information of the first user to the second user until after receipt of a response to the electronic message from the first user, and withholding release of contact information and personal information of the second user to the first user until after receipt of a response to the electronic message from the second user.

3. The method of facilitating bartering of claim 1, wherein searching and filtering comprises searching and filtering a plurality of categories and subcategories to eliminate non-matching items.

4. The method of facilitating bartering of claim 3, wherein each of the plurality of categories and subcategories is based on at least one of a type, a classification, a price range, a location of the at least one item, or a location of the first or second user.

5. The method of facilitating bartering of claim 1, wherein searching and filtering comprises using inductive matching.

6. The method of facilitating bartering of claim 1, wherein searching and filtering comprises using deductive matching.

7. The method of facilitating bartering of claim 1, wherein the at least one criteria for the trade of the first item comprises a price range for the first item, wherein the at least one of the category of items or subcategory of items comprises all available trades for goods and/or services having a value within the price range for the first item and wherein the available second item for the second user falls within the price range for the first item.

8. A system for facilitating bartering, the system for facilitating bartering comprising:
a user interface configured to enable a plurality of users to provide information about at least one item for trade and to define at least one criteria for the trade;
a server coupled to the user interface, wherein the server is configured to:
receive the information and the at least one criteria from the user interface;
generate at least one listing including the information and the at least one criteria; and
compare the listing for a first user to listings for other users to identify a match, wherein the match satisfies the at least one criteria.

9. The system for facilitating bartering of claim 8, wherein the server is further configured to generate an electronic message including information related to the match.

10. The system for facilitating bartering of claim 9, wherein the server is further configured to send the electronic message to the first user and enable the first user to respond to the electronic message and share contact information.

11. The system for facilitating bartering of claim 10, wherein the server is further configured to enter the at least one listing into a database and wherein the server is further configured to search listings in the database and filter listings that satisfy the at least one criteria for the trade of the first item.

12. The system for facilitating bartering of claim 11, wherein the search and filter of listings comprises inductive matching.

13. The system for facilitating bartering of claim 11, wherein the search and filter of listings comprises deductive matching.

14. A computer program product comprising a computer useable storage medium including a computer readable program, wherein the computer readable program includes instructions that, when executed by a processing device within a computer, cause the computer to perform operations comprising:
receiving a first input from a first user of a plurality of users, the first input comprising at least one first item for trade and at least one criteria for a trade of the first item;
receiving a second input from a second user of the plurality of users, the second input comprising at least one second item for trade, and a category of items or subcategory of items to be obtained, wherein at least one of the category of items or subcategory of items comprises a criteria for a trade of the second item;
entering the first and second inputs into a database to create a listing for each of the first item and second item;
searching and filtering items within the database to identify a match, the match comprising an available first item of the first user and an available second item of the second user, wherein the first item of the first user satisfies at least one criteria for the trade of the second item, wherein the second item of the second user satisfies at least one criteria for the trade of the first item;
generating an electronic message comprising information related to the match and sending the electronic message to at least one of the first user and the second user; and
enabling the first and second users to respond to the electronic message and enabling the first and second users to share contact information.

15. The computer program product of claim 14, the operations further comprising withholding release of contact information and personal information of the first user to the second user until after receipt of a response to the electronic message from the first user, and withholding release of contact information and personal information of the second user to the first user until after receipt of a response to the electronic message from the second user.

16. The computer program product of claim 14, wherein searching and filtering comprises searching and filtering a plurality of categories and subcategories to eliminate non-matching items.

17. The computer program product of claim 16, wherein each of the plurality of categories and subcategories is based on at least one of a type, a classification, a price range, a location of the at least one item, or a location of the first or second user.

18. The computer program product of claim 14, wherein searching and filtering comprises using inductive matching.

19. The computer program product of claim 14, wherein searching and filtering comprises using deductive matching.

20. The computer program product of claim 14, wherein the at least one criteria for the trade of the first item comprises a price range for the first item, wherein the at least one of the category of items or subcategory of items comprises all available trades for goods and/or services having a value within the price range for the first item and wherein the available second item for the second user falls within the price range for the first item.
